(19) United States
(12) Patent Application Publication
(10) Pub. No.: US 2022/0060952 A1
(43) Pub. Date: Feb. 24, 2022

(54) INFORMATION REPORTING AND RECEIVING METHOD AND APPARATUS, RELATED DEVICE AND STORAGE MEDIUM

(71) Applicants: CHINA MOBILE COMMUNICATION CO., LTD RESEARCH INSTITUTE, Beijing (CN); CHINA MOBILE COMMUNICATIONS GROUP CO., LTD., Beijing (CN)

(72) Inventors: Fang XIE, Beijing (CN); Guangyi LIU, Beijing (CN)

(21) Appl. No.: 17/509,179

(22) Filed: Oct. 25, 2021

Related U.S. Application Data
(63) Continuation of application No. PCT/CN2020/085390, filed on Apr. 17, 2020.

(30) Foreign Application Priority Data
Apr. 26, 2019 (CN) 201910346460.2

(51) Int. Cl. H04W 36/00; H04W 74/08

(52) U.S. Cl. CPC H04W 36/00837; H04W 74/0833; H04W 36/0058; H04W 36/0079

(57) ABSTRACT

Disclosed is an information reporting and receiving method and apparatus, a terminal, a network device and a storage medium. The method includes that: a terminal records relevant information of Conditional Hand Over (CHO); and the terminal reports the relevant information of CHO to a network side.

### CROSS-REFERENCE TO RELATED APPLICATION

The application is a continuation of International Patent Application No. PCT/CN2020/085390, filed on Apr. 17, 2020, which is based upon and claims priority to Chinese Patent Application No. 201910346460.2, filed on Apr. 26, 2019. The disclosures of International Patent Application No. PCT/CN2020/085390 and Chinese Patent Application No. 201910346460.2 are hereby incorporated by reference in their entireties.

### TECHNICAL FIELD

The present disclosure relates to the field of wireless communications, and in particular to an information reporting and receiving method and apparatus, a related device and a storage medium.

### BACKGROUND

Inter-cell Hand Over (HO) means that a mobile terminal, under the control of a radio access network, completes the migration of a radio link connection from a source cell to a target cell, and is the basic technical means to guarantee a seamless mobile communication service. Meanwhile, an HO mechanism in the related art is also called normal HO or immediate HO.

The HO mechanism is directly related to users' service experience in a wide area coverage network. A Conditional Hand Over (CHO) mechanism is proposed to improve the user experience in high-frequency or high-speed movement and reduce the failure rate of HO. As shown in FIG. 1, when User Equipment (UE) cannot complete HO properly due to a sudden deterioration of the channel quality between the UE and a serving cell (especially when the UE moves at a high frequency or high speed), a source base station may configure the UE to trigger measurement report at a lower threshold and carry a higher HO triggering threshold in an HO command. In the HO command, a random access resource that the UE uses in the target cell may also be carried. Once an HO threshold is met, the UE initiates a random access process to a target base station.

However, in the CHO mechanism, there is no effective solution on how to configure CHO parameters reasonably on a network side.

### SUMMARY

To solve the related technical problems, embodiments of the present disclosure provide an information reporting and receiving method and apparatus, a related device and a storage medium.

A technical solution in the embodiments of the present disclosure is implemented as follows.

At least one embodiment of the present disclosure provides an information reporting method, which is applied to a terminal, and may include the following operations.

Relevant information of CHO is recorded.

The relevant information of CHO is reported to a network side. The relevant information of CHO includes at least one of:

identity information of a first cell which is a serving cell that receives relevant configurations of CHO;

a first moment, which is a moment when the terminal initiates the CHO, or a moment when the terminal initiates a random access of the CHO;

a second moment, which is a moment when the terminal receives a normal HO command or an immediate HO command, or a moment when the terminal initiates normal HO or immediate HO;

a third moment, which is a moment when the terminal determines or experiences a Radio Link Failure (RLF) or connection failure, or a moment when the terminal reports the RLF, or a moment when the terminal loses a Radio Resource Control (RRC) connection with a source cell, or a moment when the terminal enters an idle state;

a fourth moment, which is a moment when the terminal initiates the CHO for the first time after receiving relevant configuration information of CHO, or a moment when the terminal initiates a random access of the CHO for the first time after receiving the relevant configuration information of CHO;

a time interval from a moment when the relevant configuration information of CHO is received by the terminal to the first moment;

a time interval from a moment when the relevant configuration information of CHO is received by the terminal to the fourth moment;

a moment when the terminal receives the relevant configuration information of CHO;

a time interval from a moment when the relevant configuration information of CHO is received by the terminal to the second moment;

a moment when the terminal succeeds in or fails in the normal HO or the immediate HO;

a time interval from the first moment to success or failure of a corresponding CHO;

a time interval from a moment when the relevant configuration information of CHO is received by the terminal to the fourth moment;

a moment when the CHO is failed or successful;

a time interval from a moment when the relevant configuration information of CHO is received by the terminal to success of the CHO at the terminal;

a time interval from a moment when the relevant configuration information of CHO is received by the terminal to failure of the CHO at the terminal;

a time interval from a moment when the relevant configuration information of CHO is received by the terminal to the third moment;

a time interval from the fourth moment and to success of the CHO at the terminal;

a time interval from the fourth moment to failure of the CHO at the terminal;

a time interval between the fourth moment and the third moment;

the number of times of initiating the CHO;

the number of CHO failures;

position information of the terminal when recording;

configuration of the CHO configured for the terminal, which is at least one of: an HO event or event, a corresponding parameter or parameters, or an identity of a target cell; and

relevant information of a first service performed by the terminal. The first service is the service performed by the terminal when initiating the CHO, or the service performed by the terminal before initiating the HO.

In addition, according to at least one embodiment of the present disclosure, the relevant information of CHO further includes: identity information of a second cell.

The second cell is a target cell for which the CHO is initiated, or a target cell for which a random access of the CHO is successful or failed.

In addition, according to at least one embodiment of the present disclosure, a corresponding recorded moment is in one of following forms:

an offset from reference time issued by the network side; or

absolute time.

In addition, according to at least one embodiment of the present disclosure, the CHO initiated by the terminal is a CHO initiated by the terminal for a first time according to conditions in the CHO configured for the terminal.

In addition, according to at least one embodiment of the present disclosure, the operation that the relevant information of CHO is received may include the following operation.

An RRC reconfiguration message is received, the RRC reconfiguration message carrying the relevant configuration information of CHO.

In addition, according to at least one embodiment of the present disclosure, the operation that the relevant information of CHO is recorded may include the following operation.

The relevant information of CHO is recorded according to configuration information issued by one of a network device, a network management device, or a Trace Collection Entity (TCE); or,

the relevant information of CHO is recorded according to specified information.

In addition, according to at least one embodiment of the present disclosure, the operation that the relevant information of CHO is reported to the network side may include the following operation.

The relevant information of CHO is reported to the network side via one of:

RLF report;

log measurement report information; or

a newly defined message.

In addition, according to at least one embodiment of the present disclosure, the operation that the relevant information of CHO is reported to the network side may include one of:

the terminal reports the relevant information of CHO to the network side when the terminal is in a connected state;

the terminal reports the relevant information of CHO to the network side when the terminal is changing from the idle state to the connected state; and

the terminal reports the relevant information of CHO to the network side when the terminal is in the idle state or an inactive state.

In addition, according to at least one embodiment of the present disclosure, the operation that the relevant information of CHO is reported to the network side may include one of:

the relevant information of CHO is reported initiatively to the network side;

after a request is received from the network side, the relevant information of CHO is reported to the network side;

relevant information to be recorded is informed to the network side; and after the request sent from the network side based on the informed relevant information is received, the relevant information of CHO is reported to the network side.

At least one embodiment of the present disclosure provides an information receiving method, which is applied to a network device, and may include the following operations.

The relevant information of CHO reported and recorded by the terminal is received. The recorded relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines or experiences the RLF or connection failure, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a time interval from a moment when the relevant configuration information of CHO is received by the terminal to the fourth moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a time interval from the fourth moment to success or failure of a corresponding CHO;

a moment when the CHO is failed or successful;

time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event or events, a corresponding parameter or parameters, or an identity of the target cell identity; and

the relevant information of the first service performed by the terminal. The first service is the service performed by the terminal when initiating the CHO, or the service performed by the terminal before initiating the HO.

In addition, according to at least one embodiment of the present disclosure, the relevant information of CHO further includes: the identity information of the second cell.

The second cell is the target cell that initiates the CHO, or the target cell in which the random access of the CHO is successful or failed.

In addition, according to at least one embodiment of the present disclosure, the CHO initiated by the terminal is the first CHO initiated by the terminal according to the conditions in the CHO configured for it.

In addition, according to at least one embodiment of the present disclosure, a corresponding recorded moment is in one of following forms:

the offset from the reference time issued by the network side; and

the absolute time.

In addition, according to at least one embodiment of the present disclosure, the operation that the relevant information of CHO reported and recorded by the terminal is received may include the following operation.

the relevant information of CHO reported by the terminal is received via one of:

the RLF report;

the log measurement report information; or

the newly defined message.

In addition, according to at least one embodiment of the present disclosure, when the relevant information of CHO reported by the terminal is received, the terminal satisfies one of the following conditions:

the terminal is in the connected state;

the terminal is in the process of changing from the idle state to the connected state; and

the terminal is in the idle state or the inactive state.

In addition, according to at least one embodiment of the present disclosure, the operation that the relevant information of CHO reported and recorded by the terminal is received may include one of:

the relevant information of CHO reported initiatively and recorded by the terminal is received;

a request is sent to the terminal; the relevant information of CHO reported by the terminal based on the request is received;

the relevant information to be recorded informed by the terminal is received; a request is sent based on the informed relevant information to be recorded; and the relevant information of CHO reported by the terminal based on the request is received.

At least one embodiment of the present disclosure provides an information reporting apparatus, which may include a recording unit and a reporting unit.

The recording unit is configured to record the relevant information of CHO.

The reporting unit is configured to report the relevant information of CHO to the network side. The relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In addition, according to at least one embodiment of the present disclosure, the reporting unit is configured to report the relevant information of CHO to the network side via one of:

the RLF report;

the log measurement report information; or

the newly defined message.

In addition, according to at least one embodiment of the present disclosure, the reporting unit is configured to perform one of the following operations:

the relevant information of CHO is reported initiatively to the network side;

after a request is received from the network side, the relevant information of CHO is reported to the network side;

the relevant information to be recorded is informed to the network side; and after the request sent from the network side based on the informed relevant information is received, the relevant information of CHO is reported to the network side.

At least one embodiment of the present disclosure provides an information receiving device, which may include: a receiving unit.

The receiving unit is configured to receive the relevant information of CHO reported and recorded by the terminal. The recorded relevant information of CHO includes at least one of:

the identity information of the first cell which is the serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In addition, according to at least one embodiment of the present disclosure, the receiving unit is configured to receive the relevant information of CHO reported by the terminal via one of:

the RLF report;

the log measurement report information; or

the newly defined message.

In addition, according to at least one embodiment of the present disclosure, the receiving unit is configured to perform one of the following operations:

the relevant information of CHO reported initiatively and recorded by the terminal is received;

a request is sent to the terminal; the relevant information of CHO reported by the terminal based on the request is received;

the relevant information to be recorded informed by the terminal is received; a request is sent based on the informed relevant information to be recorded; and the relevant information of CHO reported by the terminal based on the request is received.

At least one embodiment of the present disclosure provides a terminal, which may include: a first processor and a first communication interface.

The first processor is configured to record the relevant information of CHO.

The first communication interface is configured to report the relevant information of CHO to the network side. The relevant information of CHO includes at least one of:

the identity information of the first cell which is the serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In addition, according to at least one embodiment of the present disclosure, the first communication interface is configured to report the relevant information of CHO to the network side via one of:

the RLF report;

the log measurement report information; or

the newly defined message.

In addition, according to at least one embodiment of the present disclosure, the first communication interface is configured to perform one of the following operations:

the relevant information of CHO is reported initiatively to the network side;

after a request is received from the network side, the relevant information of CHO is reported to the network side;

the relevant information to be recorded is informed to the network side; and after the request sent from the network side based on the informed relevant information is received, the relevant information of CHO is reported to the network side.

At least one embodiment of the present disclosure provides a network device, which may include: a second processor and a second communication interface.

The second processor is configured to receive, through the second communication interface, the relevant information of CHO reported and recorded by the terminal. The recorded relevant information of CHO includes at least one of:

the identity information of the first cell which is the serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

a moment when the terminal initiates the CHO, or a moment when the terminal initiates the random access of the CHO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

The first moment is a moment when the terminal initiates the CHO, or a moment when the terminal initiates the random access of the CHO.

The second moment is a moment when the terminal receives the normal HO command or the immediate HO command, or a moment when the terminal initiates the normal HO or the immediate HO.

The third moment is a moment when the terminal determines the RLF, or a moment when the terminal reports the RLF, or a moment when the terminal loses the RRC connection with the source cell, or a moment when the terminal enters the idle state.

The fourth moment is a moment when the terminal initiates the CHO for the first time after receiving the relevant configuration information of CHO, or a moment when the terminal initiates the random access of the CHO for the first time after receiving the relevant configuration information of CHO.

In addition, according to at least one embodiment of the present disclosure, the second communication interface is configured to receive the relevant information of CHO reported by the terminal via one of:

the RLF report;

the log measurement report information; or

the newly defined message.

In addition, according to at least one embodiment of the present disclosure, the second communication interface is configured to perform one of the following operations:

the relevant information of CHO reported initiatively and recorded by the terminal is received;

a request is sent to the terminal; the relevant information of CHO reported by the terminal based on the request is received;

the relevant information to be recorded informed by the terminal is received; a request is sent based on the informed relevant information to be recorded; and the relevant information of CHO reported by the terminal based on the request is received.

At least one embodiment of the present disclosure provides a terminal, which may include: a first processor and a first memory configured to store a computer program capable of running in the processor.

The first processor is configured to, when running the computer program, execute the steps of any method for the terminal side.

At least one embodiment of the present disclosure provides a network device, which may include: a second processor and a second memory configured to store a computer program capable of running in the processor.

The second processor is configured to execute, when running the computer program, the steps of any method for the network device side.

At least one embodiment of the present disclosure provides a storage medium, in which a computer program is stored. When executed by the processor, the computer program implements the steps of any method for the terminal side, or implements the steps of any method for the network device side.

With the information reporting and receiving method and apparatus, the related device and the storage medium provided by the embodiments of the present disclosure, the terminal records the relevant information of CHO and reports the relevant information of CHO to the network side. In this way, the network device may use the relevant information to adjust CHO parameters, so that the configured CHO parameters are more reasonable.

### BRIEF DESCRIPTION OF THE DRAWINGS

FIG. 1 is a flowchart of CHO in related art.

FIG. 2 is a flowchart of an information reporting method according to an embodiment of the present disclosure.

FIG. 3 is a flowchart of an information transmission method according to an embodiment of the present disclosure.

FIG. 4 is a structural schematic diagram of an information reporting apparatus according to an embodiment of the present disclosure.

FIG. 5 is a structural schematic diagram of an information receiving apparatus according to an embodiment of the present disclosure.

FIG. 6 is a structural schematic diagram of a terminal according to an embodiment of the present disclosure.

FIG. 7 is a structure diagram of a network device according to an embodiment of the present disclosure.

FIG. 8 is a structural schematic diagram of an information transmission system according to an embodiment of the present disclosure.

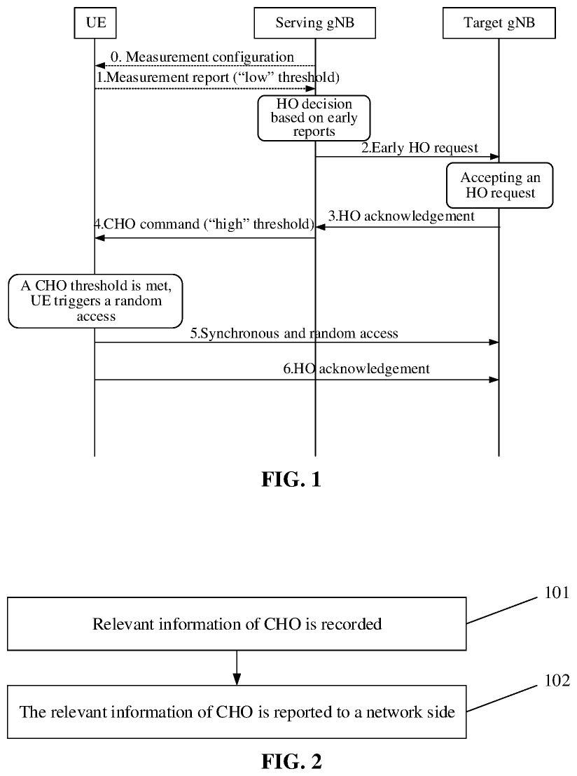

### DETAILED DESCRIPTION

The present disclosure is further described below in combination with the accompanying drawings and embodiments.

In a CHO mechanism, a base station may configure UE with CHO for multiple target cells, so how to reasonably configure CHO parameters is an urgent problem to be solved at present.

Based on this, in various embodiments of the present disclosure, when the CHO is performed, a terminal records relevant information of CHO and reports it to a network side, which can help the network side configure the reasonable CHO parameters.

The embodiments of the present disclosure provide an information reporting method, which is applied to a terminal. As shown in FIG. 2, the method may include the following steps.

At S201, relevant information of CHO is recorded.

At S202, the relevant information of CHO is reported to the network side.

The relevant information of CHO includes at least one of:

identity information of a first cell which is a serving cell that receives relevant configurations of CHO;

a first moment, which is a moment when the terminal initiates the CHO, or a moment when the terminal initiates a random access of the CHO;

a second moment, which is a moment when the terminal receives a normal HO command or an immediate HO command, or a moment when the terminal initiates normal HO or immediate HO;

a third moment, which is a moment when the terminal determines an RLF, or a moment when the terminal reports the RLF, or a moment when the terminal loses an RRC connection with a source cell, or a moment when the terminal enters an idle state;

a fourth moment, which is a moment when the terminal initiates the CHO for the first time after receiving relevant configuration information of CHO, or a moment when the terminal initiates a random access of the CHO for the first time after receiving the relevant configuration information of CHO;

a time interval from a moment when the relevant configuration information of CHO is received by the terminal to the first moment;

a moment when the terminal receives the relevant configuration information of CHO;

a time interval from a moment when the relevant configuration information of CHO is received by the terminal to the second moment;

a moment when the terminal succeeds in or fails in the normal HO or the immediate HO;

a time interval from the first moment to success or failure of a corresponding CHO;

a moment when the CHO is failed or successful;

a time interval from a moment when the relevant configuration information of CHO is received by the terminal to success of the CHO at the terminal;

a time interval from a moment when the relevant configuration information of CHO is received by the terminal to failure of the CHO at the terminal;

a time interval from a moment when the relevant configuration information of CHO is received by the terminal to the third moment;

a time interval from the fourth moment and to success of the CHO at the terminal;

a time interval from the fourth moment to failure of the CHO at the terminal;

a time interval between the fourth moment and the third moment;

the number of times of initiating the CHO;

the number of CHO failures;

position information of the terminal when recording;

configuration of the CHO configured for the terminal, which is at least one of: an HO event or event, a corresponding parameter or parameters, or an identity of a target cell; and

relevant information of a first service performed by the terminal; the first service is the service performed by the terminal when initiating the CHO, or the service performed by the terminal before initiating the HO.

The HO event may be, for example, CondEvent A3 and/or CondEvent A5. CondEvent A3: Conditional reconfiguration candidate becomes amount of offset better than PCell/PSCell. CondEvent A5: PCell/PSCell becomes worse than absolute threshold1 AND Conditional reconfiguration candidate becomes better than another absolute threshold2.

The corresponding parameter or parameters may include a3-Offset, hysteresis, timeToTrigger, and/or a5-Threshold1, a5-Threshold2, hysteresis Hysteresis, timeToTrigger.

In practical applications, because the relevant configuration information of CHO may be carried in an RRC reconfiguration (RRCReconfiguration) message, that the terminal receives the relevant configuration information of CHO may be that the terminal receives the RRC reconfiguration message.

It is to be noted that in the embodiments of the present disclosure, the time interval from a moment when the relevant configuration information of CHO is received by the terminal to other moments refers to the time interval between a moment when the terminal receives the relevant configuration information of CHO and other moments. Specifically, the time interval from a moment when the relevant configuration information of CHO is received by the terminal to the first moment refers to the time interval between a moment when the terminal receives the relevant configuration information of CHO and the first moment; the time interval from a moment when the relevant configuration information of CHO is received by the terminal to a moment when the terminal succeeds in the CHO refers to the time interval between a moment when the terminal receives the relevant configuration information of CHO and a moment when the terminal succeeds in the CHO; the time interval from a moment when the relevant configuration information of CHO is received by the terminal to a moment when the terminal fails in the CHO refers to the time interval between a moment when the terminal receives the relevant configuration information of CHO and a moment when the terminal fails in the CHO; and the time interval from a moment when the relevant configuration information of CHO is received by the terminal to the second moment refers to the time interval between a moment when the terminal receives the relevant configuration information of CHO and the second moment.

Correspondingly, the time interval from the corresponding moment to the success or failure of the CHO refers to the time interval between the corresponding moment and a moment when the corresponding CHO is successful or failed. Specifically, the time interval from the first moment to success or failure of a corresponding CHO (one of multiple CHOs initiated by the terminal) refers to the time interval between the first moment and a moment when the corresponding CHO is failed or successful; the time interval from the fourth moment to success of the CHO at the terminal refers to the time interval between the fourth moment and a moment when the terminal succeeds in the CHO; and the time interval from the fourth moment to failure of the CHO at the terminal refers to the time interval between the fourth moment and a moment when the terminal fails in the CHO.

The above time interval may also be understood as the time difference between two moments.

In the time interval from the first moment to the failure or success of the corresponding CHO, the corresponding CHO refers to the CHO corresponding to the first moment.

Immediate HO refers to the HO performed according to an immediate HO command Correspondingly, normal HO refers to the HO performed according to a normal HO command.

The immediate HO command refers to a command that instructs the terminal to perform HO immediately. The normal HO command (not the immediate HO command) is an HO command corresponding to the immediate HO command.

The normal HO command may also be called a traditional HO command.

In practical applications, there may be various forms of the corresponding moment recorded. According to the different reference time, the forms of the corresponding moment recorded are different.

Based on this, in an embodiment, the corresponding moment recorded may have one of the following forms:

an offset from the reference time issued by the network side; and

absolute time.

In practical applications, for multiple HO conditions configured for the terminal, recording information related to the CHO initiated for the first time according to conditions in the configured CHO (which may also be understood as the first CHO) may better represent the rationality of network side configuration.

Based on this, in an embodiment, the CHO initiated by the terminal and involved in the above information is the first CHO initiated by the terminal according to the conditions in the CHO configured for it.

Specifically, in the above information, the time when the terminal initiates the CHO may be a moment when the terminal initiates the first CHO according to the conditions in the configured CHO.

The time when the terminal initiates a random access of the CHO may be a moment when the terminal initiates the random access of the first CHO according to the conditions in the configured CHO.

Of course, the terminal may also record the relevant information of each CHO initiated according to the conditions in the configured multiple HO conditions.

The failure of the CHO means that an RRC connection is not successfully established with a target cell. Correspondingly, the success of the CHO means that an RRC connection is successfully established with the target cell.

In practical applications, when the terminal determines that the CHO is failed according to the conditions in the configured multiple HO conditions, the RLF may be determined; and when the terminal loses the connection with the network, the RLF may also be determined.

In practical applications, the relevant information of the first service may include a Single-Network Slice Selection Assistance Info (S-NSSAI) ID, a 5G Quality of Service (QoS) indicator, a flow ID or a QoS Class Identifier (QCI), etc.

In an embodiment, the relevant information of CHO may also include:

identity information of a second cell.

The second cell is the target cell that initiates the CHO, or the target cell in which the random access of the CHO is successful or failed.

In practical applications, the relevant information recorded by the terminal may be required by some devices or may be predefined.

Based on this, in an embodiment, that the relevant information of CHO is recorded may include that:

the relevant information of CHO is recorded according to the configuration information issued by one of the following devices: base station; core network element; network management device; and TCE; or

the relevant information of CHO is recorded according to specified information.

When recording the relevant information of CHO according to the configuration information configured by the device, the terminal needs to acquire the configuration information configured by the device.

Based on this, in an embodiment, when the relevant information of CHO is recorded according to the received configuration information, the method may also include the following operation.

The configuration information sent by one of the following devices is received:

the base station; the core network element; the network management device; and the TCE.

Here, when recording the relevant information of CHO according to the configuration information configured by the base station, the terminal receives the configuration information sent by the base station; when recording the relevant information of CHO according to the configuration information configured by the core network element, the terminal receives the configuration information sent by the core network element; when recording the relevant information of CHO according to the configuration information configured by the network management device, the terminal receives the configuration information sent by the network management device; and when recording the relevant information of CHO according to the configuration information configured by the TCE, the terminal receives the configuration information sent by the TCE.

In practical applications, the main function of the TCE is to collect some information of the base station and the terminal for network device providers or carriers to use.

In practical applications, the terminal may use the existing message to report the relevant information of CHO, or use the newly defined message to report the relevant information of CHO.

Based on this, in an embodiment, that the relevant information of CHO is reported to the network side may include that:

the relevant information of CHO is reported to the network side via one of:

the RLF report;

the log measurement report information; or

the newly defined message.

The newly defined message may be called CHO information, etc. The format of the newly defined message may be determined as needed, for example, may refer to the format of the RLF report or the log measurement report information. The embodiments of the present disclosure do not limit the format of the newly defined message.

When the relevant information of CHO is reported, the terminal may be in a connected state, or in the process of changing from an idle state to the connected state, or in the idle state or an inactive state.

Based on this, in an embodiment, that the relevant information of CHO is reported to the network side may include one of:

the terminal reports the relevant information of CHO to the network side when being in the connected state;

the terminal reports the relevant information of CHO to the network side when the terminal is changing from the idle state to the connected state; and

the terminal reports the relevant information of CHO to the network side when being in the idle state or the inactive state.

When the terminal is in the idle state, the connections of both a wireless side and a core network are released. When the terminal is in the inactive state, the connection of the wireless side is released, but the connection of the core network still exists.

In practical applications, the reporting behavior of the terminal includes the following situations.

In the first situation, the network side requests the reporting.

In the second situation, the terminal reports initiatively.

In the third situation, the terminal notifies the network side of relevant log information and sends it at the request of the network side.

Based on this, in an embodiment, that the relevant information of CHO is reported to the network side may include one of:

the relevant information of CHO is reported initiatively to the network side;

after a request is received from the network side, the relevant information of CHO is reported to the network side;

the relevant information to be recorded is informed to the network side; and after the request sent from the network side based on the informed relevant information is received, the relevant information of CHO is reported to the network side.

Correspondingly, the embodiments of the present disclosure also provide an information receiving method, which is applied to a network device (specifically a base station, for example, the gNB in the 5-th generation mobile communication technology (5G) system), and may include that:

the relevant information of CHO reported and recorded by the terminal is received. The recorded relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

After receiving the relevant information of CHO, the network device may use the relevant information to adjust CHO parameters, so that the configured CHO parameters are more reasonable.

When recording the relevant information of CHO according to the configuration information configured by the network device, the network device needs to configure the relevant information.

Based on this, in an embodiment, the method may further include the following operation.

Information is configured for the terminal. The configured information is used for the terminal to record the relevant information of CHO.

In an embodiment, that the relevant information of CHO reported and recorded by the terminal is received may include the following operation.

the relevant information of CHO reported by the terminal is received via one of:

the RLF report;

the log measurement report information; or

the newly defined message.

In an embodiment, when the relevant information of CHO reported by the terminal is received, the terminal satisfies one of the following conditions:

the terminal is in the connected state;

the terminal is in the process of changing from the idle state to the connected state; and

the terminal is in the idle state or the inactive state.

In an embodiment, that the relevant information of CHO reported and recorded by the terminal is received may include one of:

the relevant information of CHO reported initiatively and recorded by the terminal is received;

a request is sent to the terminal; the relevant information of CHO reported by the terminal based on the request is received;

the relevant information to be recorded informed by the terminal is received; a request is sent based on the informed relevant information to be recorded; and the relevant information of CHO reported by the terminal based on the request is received.

According to the identification information of the first cell, the base station which has received the information reported by the UE can forward the information to the base station where the first cell is located, that is, the serving base station for configuring CHO. Since the UE attempts to access the target base station only when the condition for CHO is met, which is different from a traditional HO process in which a UE accesses the target base station once the UE receives the HO command, the potential candidate target base station needs to reserve dedicated random access resources for the UE before the UE actually performs HO, which may cause certain resource occupation and waste. According to the information reported by the UE, the serving base station can determine whether the configuration timing or parameters of CHO needs to be optimized to save the occupation of network-side resources.

For example, according to the time interval from the moment when the configuration information related to CHO is received by a UE to the first moment, or the moment when the configuration information related to CHO is received by the UE and the first moment, or the moment when the configuration information related to CHO is received by the UE and the fourth moment, the serving base station can determine whether the configuration related to CHO is too early or whether the threshold for the event is configured appropriately. If the interval is long, it means that the dedicated random access resources reserved for the UE by multiple potential candidate target base stations are too long, which is a waste of resources on the network-side. Then, the subsequent serving base stations can delay the negotiation and configuration process related to CHO, or reduce the threshold for event triggering (e.g., reduce the offset for A3 event, or increase the threshold1 for A5 event and/or reduce the threshold2 for A5 event), such that it will be easier for the UE to trigger CHO.

In at least some embodiments, when the time interval from the moment when the configuration information related to CHO is received by the UE to the second moment is always small or the second moment always appears earlier, it indicates that the UE receives the HO command soon before triggering CHO, then the resources configured for CHO on the network-side are meaningless, and the servicing base station can consider canceling the configuration of CHO. If the interval is always long or the second moment always appears very late, it indicates that the condition for CHO has not been triggered for a long time. Subsequently, the serving base station can delay the negotiation and configuration process related to CHO, or reduce the threshold for event triggering, so that it will be easier for the UE to trigger CHO.

In at least some embodiments, according to the time interval from the first moment to failure or success of the corresponding CHO, or the time interval from the fourth moment to the success or failure of CHO for the UE, the target base station meeting the CHO conditions can determine the length of time consumed by the UE in the CHO process, and can indirectly determine whether the random access resources of the UE in the target cell are configured appropriately, or whether dedicated random access resources need to be configured, such as whether the HO fails or succeeds at a very late time due to multiple preamble or msgA collisions.

In at least some embodiments, according to the time interval from the moment when the configuration information related to CHO is received by the UE to the success or failure of CHO, or the time interval from the moment when the configuration information related to CHO is received by the UE to the third moment, or the third moment, the serving base station can determine whether the timing or event parameter threshold of CHO configuration is configured appropriately. If the interval is always long, it indicates that the CHO is configured too early or the trigger condition of CHO is too strict (e.g., the configured offset for A3 event is too high, resulting in HO is triggered at a very late time), then the CHO shall be delayed or the trigger threshold for CHO shall be reduced. If the interval is always short, it indicates that the CHO is configured too late or the trigger condition of CHO is too low (if the configured offset for A3 event is too low), it is needed to configure the CHO in advance or raise the trigger threshold for CHO.

In at least some embodiments, according to the time interval between the fourth moment and the third moment, the serving base station can know when RLF occurs after the UE initiates the CHO, so as to infer whether the timing of the CHO is appropriate. If the interval is very short, it indicates that the CHO occurs very late, and the serving base station shall adjust the parameters for triggering the CHO, such that the CHO is triggered in advance. On the contrary, if the interval is very long, it indicates that the CHO occurs very early. The serving base station needs to adjust the parameters for triggering the CHO, so that the CHO is delayed.

In at least some embodiments, according to the number of times for which CHO is initiated or the number of times for which the CHO is failed, and the identification information of the second cell, the serving base station can know the candidate target cells for which the CHO is triggered by the UE, or even for which the CHO is failed, so as to further determine whether the trigger conditions corresponding to the target cell are appropriate. Further, with reference to the information of the previous time interval or information of multiple moments, the serving base station can determine whether it is needed to configure the CHO to be triggered in advance or to be delayed.

In at least some embodiments, according to the configuration of CHO for the UE, the network-side can determine whether the event and threshold are configured appropriately. If the UE has not triggered HO after receiving the CHO configuration, but RLF occurs for the UE in the source cell, it indicates that the HO triggering threshold configured for CHO is too high, which makes it difficult for the UE to trigger HO and HO occurs at a very late time. Subsequently, the base station needs to lower the HO threshold so that the UE triggers the HO early to avoid the UE triggers the HO at a very late time. According to the location information recorded by the UE, that is, the location where the CHO configuration is received or where the CHO is triggered or where the link fails or the HO fails, the serving base station can determine whether the radio coverage corresponding to the location needs to be enhanced, or whether the CHO needs to be configured when the UE is in the location, or whether the configuration of CHO needs to be advanced or delayed.

In at least some embodiments, according to the relevant information of the first service carried out by the UE, the serving base station can determine whether it is suitable to configure CHO when the UE carries out the service. For example, a large number of UEs report that CHO fails or service performance decreases when carrying out a slice service, such as services with high requirements for uplink feedback (e.g., industrial control, visual supervision, etc.), the serving base station is still waiting for the UE's feedback because the serving base station does not know when the UE triggered the CHO, and thus the uplink service experience is poor. Therefore, the serving base station needs to avoid configuring CHO during the service.

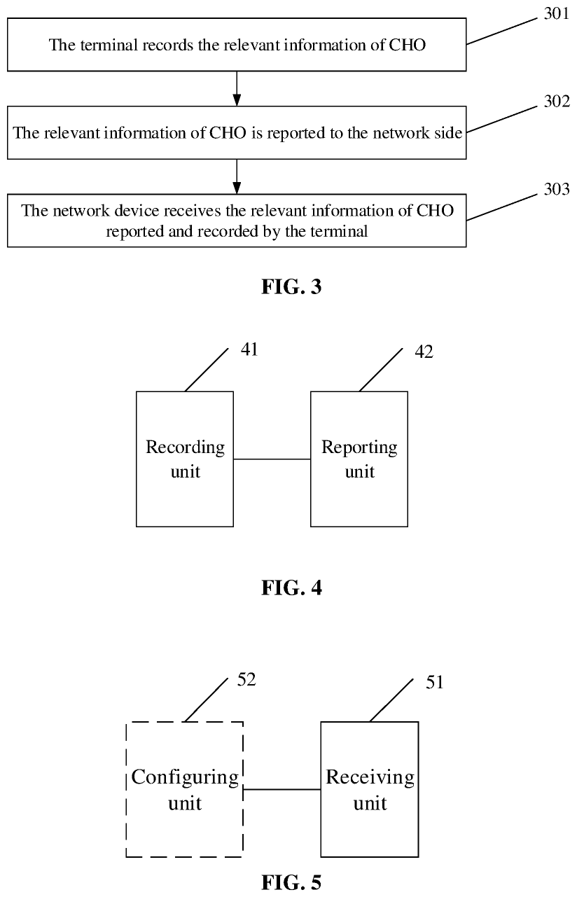

The embodiments of the present disclosure provide an information receiving method. As shown in FIG. 3, the method may include the following steps.

At S301, the terminal records the relevant information of CHO.

At S302, the relevant information of CHO is reported to the network side.

Here, the relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

At S303, the network device receives the relevant information of CHO reported and recorded by the terminal.

It is to be noted that the specific processing process of the terminal and the network device has been described in detail above and will not be repeated here.

With the information receiving method provided by the embodiments of the present disclosure, the terminal records the relevant information of CHO and reports it to the network side, so that the network device may use the relevant information to adjust the CHO parameters, and the configured CHO parameters are more reasonable.

In order to implement the method of the embodiments of the present disclosure, the embodiments of the present disclosure also provide an information reporting apparatus, which is arranged on the terminal. As shown in FIG. 4, the apparatus may include: a recording unit 41 and a reporting unit 42.

The recording unit 41 is configured to record the relevant information of CHO.

The reporting unit 42 is configured to report the relevant information of CHO to the network side. The relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In an embodiment, the recording unit 41 is configured to:

record the relevant information of CHO according to the configuration information issued by one of the following devices: the base station; the core network element; the network management device; and the TCE; or

record the relevant information of CHO according to specified information.

In an embodiment, the recording unit 41 is further configured to receive the configuration information sent by one of the following devices:

the base station; the core network element; the network management device;

and the TCE.

In an embodiment, the reporting unit 42 is configured to report the relevant information of CHO to the network side via one of:

the RLF report;

the log measurement report information; or

the newly defined message.

In an embodiment, the reporting unit 42 is configured to perform one of the following operations:

the terminal reports the relevant information of CHO to the network side when being in the connected state;

the terminal reports the relevant information of CHO to the network side when the terminal is changing from the idle state to the connected state; and

the terminal reports the relevant information of CHO to the network side when being in the idle state or the inactive state.

In an embodiment, the reporting unit 42 is configured to perform one of the following operations:

the relevant information of CHO is reported initiatively to the network side;

after a request is received from the network side, the relevant information of CHO is reported to the network side;

the relevant information to be recorded is informed to the network side; and after the request sent from the network side based on the informed relevant information is received, the relevant information of CHO is reported to the network side.

In practical applications, the recording unit 41 may be realized by a processor in the information reporting apparatus, and the reporting unit 42 may be realized by the processor in the information reporting apparatus in combination with a communication interface.

It is to be noted that when the information reporting apparatus provided by the embodiments reports the information, the apparatus is illustrated only by the division of each program module mentioned above. In practical applications, the above processing may be assigned to different program modules to complete according to needs, that is, the internal structure of the client device is divided into different program modules to complete all or part of the processing described above. In addition, the information reporting apparatus provided in the embodiments belongs to the same concept of the information reporting method embodiments, and details about a specific implementation process thereof refer to the method embodiments, and will not be elaborated herein.

In order to implement the method for the network device side of the embodiments of the present disclosure, the embodiments of the present disclosure also provide an information receiving apparatus, which is arranged on the network device. As shown in FIG. 5, the apparatus may include: a receiving unit 51.

The receiving unit 51 is configured to receive the relevant information of CHO reported and recorded by the terminal. The recorded relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In an embodiment, as shown in FIG. 5, the apparatus may also include: a configuring unit 52, which is configured to configure information for the terminal. The configured information is used for the terminal to record the relevant information of CHO.

In an embodiment, the receiving unit 51 is configured to receive the relevant information of CHO reported by the terminal via one of:

the RLF report;

the log measurement report information; or

the newly defined message.

In an embodiment, when the relevant information of CHO reported by the terminal is received, the terminal satisfies one of the following conditions:

the terminal is in the connected state;

the terminal is in the process of changing from the idle state to the connected state; and

the terminal is in the idle state or the inactive state.

In an embodiment, the receiving unit 51 is configured to perform one of the following operations:

the relevant information of CHO reported initiatively and recorded by the terminal is received;

a request is sent to the terminal; the relevant information of CHO reported by the terminal based on the request is received;

the relevant information to be recorded informed by the terminal is received; a request is sent based on the informed relevant information to be recorded; and the relevant information of CHO reported by the terminal based on the request is received.

In practical applications, the receiving unit 51 and the configuring unit 52 may be realized by the processor in the information receiving apparatus in combination with a communication interface.

It is to be noted that when the information receiving apparatus provided by the embodiments receives the information, the apparatus is illustrated only by the division of each program module mentioned above. In practical applications, the above processing may be assigned to different program modules to complete according to needs, that is, the internal structure of the client device is divided into different program modules to complete all or part of the processing described above. In addition, the information receiving apparatus provided in the embodiments belongs to the same concept of the information receiving method embodiments, and details about a specific implementation process thereof refer to the method embodiments, and will not be elaborated herein.

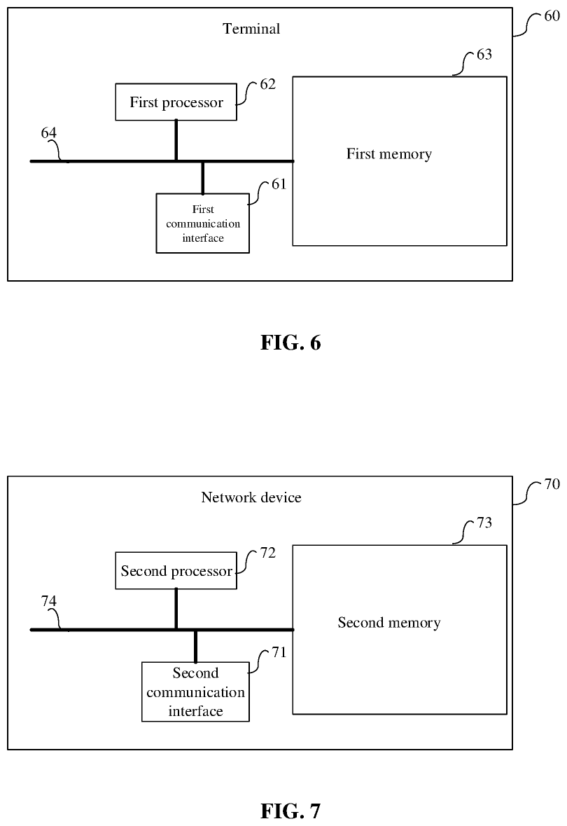

Based on hardware implementation of each program module, for implementing the method for the terminal side in the embodiments of the present disclosure, the embodiments of the present disclosure also provide a terminal. As shown in FIG. 6, the terminal 60 includes a first communication interface 61 and a first processor 62.

The first communication interface 61 can perform information interaction with the network device.

The first processor 62 is connected with the first communication interface 61 to implement information interaction with the network device, and is configured to run a computer program to execute the method provided in one or more technical solutions for the terminal side. The computer program is stored in a first memory 63.

Specifically, the first processor 62 is configured to record the relevant information of CHO.

The first communication interface 61 is configured to report the relevant information of CHO to the network side. The relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In an embodiment, the first processor 62 is configured to:

record the relevant information of CHO according to the configuration information issued by one of the following devices: the base station; the core network element; the network management device; and the TCE; or

record the relevant information of CHO according to the specified information.

In an embodiment, the first communication interface 61 is further configured to receive the configuration information sent by one of the following devices:

the base station; the core network element; the network management device; and the TCE.

In an embodiment, the first communication interface 61 is configured to report the relevant information of CHO to the network side via one of:

the RLF report;

the log measurement report information; or

the newly defined message.

In an embodiment, the first communication interface 61 is configured to perform one of the following operations:

the terminal reports the relevant information of CHO to the network side when being in the connected state;

the terminal reports the relevant information of CHO to the network side when the terminal is changing from the idle state to the connected state; and

the terminal reports the relevant information of CHO to the network side when being in the idle state or the inactive state.

In an embodiment, the first communication interface 61 is configured to perform one of the following operations:

the relevant information of CHO is reported initiatively to the network side;

after a request is received from the network side, the relevant information of CHO is reported to the network side;

the relevant information to be recorded is informed to the network side; and after the request sent from the network side based on the informed relevant information is received, the relevant information of CHO is reported to the network side.

It is to be noted that the specific processing process of the first processor 62 and the first communication interface 61 is detailed in the method embodiments and will not be repeated here.

Of course, in practical applications, each component in the terminal 60 is coupled through a bus system 64. It may be understood that the bus system 64 is configured to implement connection communication between these components. The bus system 64 includes a data bus and further includes a power bus, a control bus and a state signal bus. However, for clear description, various buses in FIG. 6 are marked as the bus system 64.

The first memory 63 in the embodiments of the present disclosure is configured to store various types of data to support the operation of the terminal 60. Examples of the data include any computer program operated in the terminal 60.

The method disclosed in the embodiments of the present disclosure may be applied to the first processor 62 or implemented by the first processor 62. The first processor 62 may be an integrated circuit chip with a signal processing capability. In an implementation process, the steps of the method may be accomplished by an integrated logic circuit of hardware in the first processor 62 or an instruction in a software form. The first processor 62 may be a universal processor, a Digital Signal Processor (DSP) or another Programmable Logic Device (PLD), a discrete gate or transistor logic device, a discrete hardware component, etc. The first processor 62 may implement or execute each method, step and logical block diagram disclosed in the embodiments of the present disclosure. The universal processor may be a microprocessor, any conventional processor or the like. The steps of the method disclosed in combination with the embodiments of the present disclosure may be directly embodied to be executed and completed by a hardware decoding processor or executed and completed by a combination of hardware and software modules in the decoding processor. The software module may be located in a storage medium, and the storage medium is located in the first memory 63. The first processor 62 reads information in the first memory 63 and completes the steps of the method in combination with hardware.

In an exemplary embodiment, the terminal 60 may be realized by one or more Application Specific Integrated Circuits (ASICs), DSPs, Programmable Logic Devices (PLDs), Complex Programmable Logic Devices (CPLDs), Field-Programmable Gate Array (FPGAs), universal processors, controllers, Micro Controller Units (MCUs), microprocessors, or other electronic components, and is configured to execute the above method.

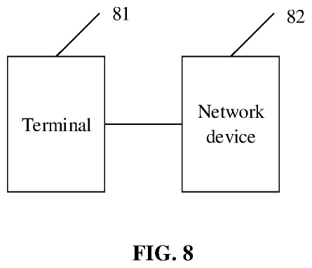

Based on hardware implementation of the above program modules, for implementing the method for the network device side in the embodiments of the present disclosure, as shown in FIG. 7, the network device 70 may include a second communication interface 71 and a second processor 72.

The second communication interface 71 can perform information interaction with the terminal.

The second processor 72 is connected with the second communication interface 71 to implement information interaction with the terminal, and is configured to run the computer program to execute the method provided in one or more technical solutions for the network device side. The computer program is stored in the second memory 73.

Specifically, the second processor 72 is configured to receive, through the second communication interface 71, the relevant information of CHO reported and recorded by the terminal. The recorded relevant information of CHO includes at least one of:

the identity information of the first cell which is a serving cell that receives the relevant configurations of CHO;

the first moment, which is a moment when the terminal initiates the CHO, or a moment when the terminal initiates the random access of the CHO;

the second moment, which is a moment when the terminal receives the normal HO command or the immediate HO command, or a moment when the terminal initiates the normal HO or the immediate HO;

the third moment, which is a moment when the terminal determines the RLF, or a moment when the terminal reports the RLF, or a moment when the terminal loses the RRC connection with the source cell, or a moment when the terminal enters the idle state;

the fourth moment, which is a moment when the terminal initiates the CHO for the first time after receiving the relevant configuration information of CHO, or a moment when the terminal initiates the random access of the CHO for the first time after receiving the relevant configuration information of CHO;

the time interval from a moment when the relevant configuration information of CHO is received by the terminal to the first moment;

a moment when the terminal receives the relevant configuration information of CHO;

the time interval from a moment when the relevant configuration information of CHO is received by the terminal to the second moment;

a moment when the terminal succeeds in or fails in the normal HO or the immediate HO;

the time interval from the first moment to success or failure of a corresponding CHO;

a moment when the CHO is failed or successful;

the time interval from a moment when the relevant configuration information of CHO is received by the terminal to success of the CHO at the terminal;

the time interval from a moment when the relevant configuration information of CHO is received by the terminal to failure of the CHO at the terminal;

the time interval from a moment when the relevant configuration information of CHO is received by the terminal to the third moment;

the time interval from the fourth moment and to success of the CHO at the terminal;

the time interval from the fourth moment to failure of the CHO at the terminal;

the time interval between the fourth moment and the third moment;

the number of times of initiating the CHO;

the number of CHO failures;

the position information of the terminal when recording;

the configuration of the CHO configured for the terminal, which is at least one of: the HO event, the specific threshold, and the target cell identity; and

the relevant information of the first service performed by the terminal. The first service is the service performed by the terminal when initiating the CHO, or the service performed by the terminal before initiating the HO.

In an embodiment, the second communication interface 71 is configured to receive the relevant information of CHO reported by the terminal via one of:

the RLF report;

the log measurement report information; or

the newly defined message.

In an embodiment, when the relevant information of CHO reported by the terminal is received, the terminal satisfies one of the following conditions:

the terminal is in the connected state;

the terminal is in the process of changing from the idle state to the connected state; and

the terminal is in the idle state or the inactive state.

In an embodiment, the second communication interface 71 is configured to perform one of the following operations:

the relevant information of CHO reported initiatively and recorded by the terminal is received;

a request is sent to the terminal; the relevant information of CHO reported by the terminal based on the request is received;

the relevant information to be recorded informed by the terminal is received; a request is sent based on the informed relevant information to be recorded; and the relevant information of CHO reported by the terminal based on the request is received.

It is to be noted that the specific processing process of the second processor 72 and the second communication interface 71 is detailed in the method embodiments and will not be repeated here.

Of course, in practical applications, each component in the network device 70 is coupled through a bus system 74. It may be understood that the bus system 74 is configured to implement connection communication between these components. The bus system 74 includes a data bus and further includes a power bus, a control bus and a state signal bus. However, for clear description, various buses in FIG. 7 are marked as the bus system 74.

The second memory 73 in the embodiments of the present disclosure is configured to store various types of data to support the operation of the network device 70. Examples of the data include any computer program operated in the network device 70.

The method disclosed in the embodiments of the present disclosure may be applied to the second processor 72 or implemented by the second processor 72. The second processor 72 may be an integrated circuit chip with a signal processing capability. In an implementation process, the steps of the method may be accomplished by an integrated logic circuit of hardware in the second processor 72 or an instruction in a software form. The second processor 72 may be a universal processor, a DSP or other PLD, a discrete gate or transistor logic device, a discrete hardware component, etc. The second processor 72 may implement or execute each method, step and logical block diagram disclosed in the embodiments of the present disclosure. The universal processor may be a microprocessor, any conventional processor or the like. The steps of the method disclosed in combination with the embodiments of the present disclosure may be directly embodied to be executed and completed by a hardware decoding processor or executed and completed by a combination of hardware and software modules in the decoding processor. The software module may be located in a storage medium, and the storage medium is located in the second memory 73. The second processor 72 reads information in the second memory 73 and completes the steps of the method in combination with hardware.

In an exemplary embodiment, the network device 70 may be realized by one or more ASICs, DSPs, PLDs, CPLDs, FPGAs, universal processors, controllers, MCUs, microprocessors, or other electronic components, and is configured to execute the above method.

Understandably, the memories (the first memory 63 and the second memory 73) in the embodiments of the present disclosure may be a volatile memory or a nonvolatile memory, or may include both the volatile and nonvolatile memories. The nonvolatile memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface storage, a compact disc, or a Compact Disc Read-Only Memory (CD-ROM). The magnetic surface memory may be a disk memory or a tape memory. The volatile memory may be a Random Access Memory (RAM), and is used as an external high-speed cache. It is exemplarily but unlimitedly described that RAMs in various forms may be adopted, such as a Static Random Access Memory (SRAM), a Synchronous Static Random Access Memory (SSRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a SyncLink Dynamic Random Access Memory (SLDRAM) and a Direct Rambus Random Access Memory (DRRAM). The memory described in the embodiments of the present disclosure is intended to include, but not limited to, memories of these and any other proper types.

In order to implement the method of the embodiments of the present disclosure, the embodiments of the present disclosure also provide an information transmission system. As shown in FIG. 8, the system may include: a terminal 81 and a network device 82.

The terminal 81 is configured to record the relevant information of CHO, and report the relevant information of CHO to the network side.

The network device 82 is configured to receive the relevant information of CHO reported and recorded by the terminal 81.

It is to be noted that the specific processing process of the terminal 81 and the network device 82 has been described in detail above and will not be repeated here.

In an exemplary embodiment, the embodiments of the present disclosure also provide a storage medium, namely a computer storage medium, specifically a computer-readable storage medium, which includes, for example, the first memory 63 in which the computer program is stored. The computer program may be executed by the first processor 62 of the terminal 60 to complete the steps of the method for the terminal side. For another example, the storage medium includes the second memory 73 in which the computer program is stored. The computer program may be executed by the second processor 72 of the network device 70 to complete the steps of the method for the network device side. The computer-readable storage medium may be a memory such as an FRAM, a ROM, a PROM, an EPROM, an EEPROM, a flash memory, a magnetic surface memory, a compact disc, or a CD-ROM.

It is to be noted that “first”, “second” and the like are adopted to distinguish similar objects and not intended to describe a specific sequence or order.

In addition, the technical solutions recorded in the embodiments of the present disclosure may be freely combined without conflicts.

The above is only the preferred embodiments of the present disclosure and not intended to limit the protection scope of the present disclosure.

1. An information reporting method, applied to a terminal, comprising:
recording relevant information of Conditional Hand Over (CHO); and
reporting the relevant information of CHO to a network side; wherein the relevant information of CHO comprises at least one of:
identity information of a first cell which is a serving cell that receives relevant configurations of CHO;
a first moment, which is a moment when the terminal initiates the CHO, or a moment when the terminal initiates a random access of the CHO;
a second moment, which is a moment when the terminal receives a normal Hand Over (HO) command or an immediate HO command, or a moment when the terminal initiates normal HO or immediate HO;
a third moment, which is a moment when the terminal determines or experiences a Radio Link Failure (RLF) or connection failure, or a moment when the terminal reports the RLF, or a moment when the terminal loses a Radio Resource Control (RRC) connection with a source cell, or a moment when the terminal enters an idle state;
a fourth moment, which is a moment when the terminal initiates the CHO for a first time after receiving relevant configuration information of CHO, or a moment when the terminal initiates a random access of the CHO for a first time after receiving the relevant configuration information of CHO;
a time interval from a moment when the relevant configuration information of CHO is received by the terminal to the first moment;
a time interval from a moment when the relevant configuration information of CHO is received by the terminal to the fourth moment;
a moment when the terminal receives the relevant configuration information of CHO;
a time interval from a moment when the relevant configuration information of CHO is received by the terminal to the second moment;
a moment when the terminal succeeds in or fails in the normal HO or the immediate HO;
a time interval from the first moment to success or failure of a corresponding CHO;
a time interval from the fourth moment to success or failure of a corresponding CHO;
a moment when the CHO is failed or successful;
a time interval from a moment when the relevant configuration information of CHO is received by the terminal to success of the CHO at the terminal;
a time interval from a moment when the relevant configuration information of CHO is received by the terminal to failure of the CHO at the terminal;
a time interval from a moment when the relevant configuration information of CHO is received by the terminal to the third moment;
a time interval from the fourth moment and to success of the CHO at the terminal;
a time interval from the fourth moment to failure of the CHO at the terminal;
a time interval between the fourth moment and the third moment;
a number of times of initiating the CHO;
a number of CHO failures;
position information of the terminal when recording;
configuration of the CHO configured for the terminal, the configuration being at least one of: an HO event or events, a corresponding parameter or parameters, or an identity of a target cell; or
relevant information of a first service performed by the terminal; the first service being a service performed by the terminal when initiating the CHO, or a service performed by the terminal before initiating the HO.

2. The method of claim 1, wherein the relevant information of CHO further comprises:
identity information of a second cell; the second cell is a target cell for which the CHO is initiated, or a target cell for which a random access of the CHO is successful or failed.

3. The method of claim 1, wherein a corresponding recorded moment is in one of following forms:
an offset from reference time issued by the network side; or
absolute time.

4. The method of claim 1, wherein the CHO initiated by the terminal is a CHO initiated by the terminal for a first time according to conditions in the CHO configured for the terminal.

5. The method of claim 1, wherein receiving the relevant configuration information of CHO comprises:
receiving an RRC reconfiguration message carrying the relevant configuration information of CHO.

6. The method of claim 1, wherein recording the relevant information of CHO comprises:
recording the relevant information of CHO according to configuration information issued by one of a network device, a network management device, or a Trace Collection Entity (TCE); or
recording the relevant information of CHO according to specified information.

7. The method of claim 1, wherein reporting the relevant information of CHO to the network side comprises:
reporting the relevant information of CHO to the network side via one of:
RLF report;
log measurement report information; or
a newly defined message.

8. The method of claim 1, wherein reporting the relevant information of CHO to the network side comprises one of:
reporting, by the terminal, the relevant information of CHO to the network side when the terminal is in a connected state;
reporting, by the terminal, the relevant information of CHO to the network side when the terminal is changing from the idle state to the connected state; or
reporting, by the terminal, the relevant information of CHO to the network side when the terminal is in the idle state or an inactive state.

9. The method of claim 1, wherein reporting the relevant information of CHO to the network side comprises one of:
reporting initiatively the relevant information of CHO to the network side;
after receiving a request from the network side, reporting the relevant information of CHO to the network side; or
informing the network side of the relevant information to be recorded; and after receiving a request sent from the network side based on the informed relevant information, reporting the relevant information of CHO to the network side.

10. An information receiving method, applied to a network device, comprising:
receiving relevant information of Conditional Hand Over (CHO) reported and recorded by a terminal; wherein the recorded relevant information of CHO comprises at least one of:
identity information of a first cell which is a serving cell that receives relevant configurations of CHO;
a first moment, which is a moment when the terminal initiates the CHO, or a moment when the terminal initiates a random access of the CHO;
a second moment, which is a moment when the terminal receives a normal Hand Over (HO) command or an immediate HO command, or a moment when the terminal initiates normal HO or immediate HO;
a third moment, which is a moment when the terminal determines or experiences a Radio Link Failure (RLF) or connection failure, or a moment when the terminal reports the RLF, or a moment when the terminal loses a Radio Resource Control (RRC) connection with a source cell, or a moment when the terminal enters an idle state;
a fourth moment, which is a moment when the terminal initiates the CHO for a first time after receiving relevant configuration information of CHO, or a moment when the terminal initiates a random access of the CHO a the first time after receiving the relevant configuration information of CHO;
a time interval from a moment when the relevant configuration information of CHO is received by the terminal to the first moment;
a time interval from a moment when the relevant configuration information of CHO is received by the terminal to the fourth moment;
a moment when the terminal receives the relevant configuration information of CHO;
a time interval from a moment when the relevant configuration information of CHO is received by the terminal to the second moment;
a moment when the terminal succeeds in or fails in the normal HO or the immediate HO;
a time interval from the first moment to success or failure of a corresponding CHO;
a time interval from the fourth moment to success or failure of a corresponding CHO;
a moment when the CHO is failed or successful;
a time interval from a moment when the relevant configuration information of CHO is received by the terminal to success of the CHO at the terminal;
a time interval from a moment when the relevant configuration information of CHO is received by the terminal to failure of the CHO at the terminal;
a time interval from a moment when the relevant configuration information of CHO is received by the terminal to the third moment;
a time interval from the fourth moment and to success of the CHO at the terminal;
a time interval from the fourth moment to failure of the CHO at the terminal;
a time interval between the fourth moment and the third moment;
a number of times of initiating the CHO;
a number of CHO failures;
position information of the terminal when recording;
configuration of the CHO configured for the terminal, the configuration being at least one of: an HO event or events, a corresponding parameter or parameters, or an identity of a target cell; or
relevant information of a first service performed by the terminal; wherein the first service is a service performed by the terminal when initiating the CHO, or a service performed by the terminal before initiating the HO.

11. The method of claim 10, wherein the relevant information of CHO further comprises:
identity information of a second cell; the second cell is a target cell for which the CHO is initiated, or a target cell for which a random access of the CHO is successful or failed.

12. The method of claim 10, wherein the CHO initiated by the terminal is a CHO initiated by the terminal for a first time according to conditions in the CHO configured for the terminal.

13. The method of claim 10, wherein a corresponding recorded moment is in one of following forms:
an offset from reference time issued by a network side; or
absolute time.

14. The method of claim 10, wherein receiving the relevant information of CHO reported and recorded by the terminal comprises:
receiving the relevant information of CHO reported by the terminal via one of:
RLF report;
log measurement report information; or
a newly defined message.

15. The method of claim 10, wherein when receiving the relevant information of CHO reported by the terminal, the terminal satisfies one of the following conditions:
the terminal is in a connected state;
the terminal is in a process of changing from an idle state to the connected state; or
the terminal is in the idle state or an inactive state.

16. The method of claim 10, wherein receiving the relevant information of CHO reported and recorded by the terminal comprises one of:
receiving the relevant information of CHO reported initiatively and recorded by the terminal;
sending a request to the terminal, and receiving the relevant information of CHO reported by the terminal based on the request; or
receiving relevant information to be recorded informed by the terminal, sending a request based on the informed information to be recorded and receiving the relevant information of CHO reported by the terminal based on the request.

17. A terminal, comprising: a first processor and a first memory configured to store a computer program executable by the first processor;
the first processor is configured to execute, when running the computer program, steps of the method of claim 1.

18. A network device, comprising: a second processor and a second memory configured to store a computer program executable by the second processor;
the second processor is configured to execute, when running the computer program, steps of the method of claim 10.

19. A non-transitory storage medium having stored thereon a computer program that when executed by a processor, performs steps of a method, the method comprising:
recording relevant information of Conditional Hand Over (CHO); and
reporting the relevant information of CHO to a network side; wherein the relevant information of CHO comprises at least one of:
identity information of a first cell which is a serving cell that receives relevant configurations of CHO;
a first moment, which is a moment when a terminal initiates the CHO, or a moment when the terminal initiates a random access of the CHO;
a second moment, which is a moment when the terminal receives a normal Hand Over (HO) command or an immediate HO command, or a moment when the terminal initiates normal HO or immediate HO;
a third moment, which is a moment when the terminal determines or experiences a Radio Link Failure (RLF) or connection failure, or a moment when the terminal reports the RLF, or a moment when the terminal loses a Radio Resource Control (RRC) connection with a source cell, or a moment when the terminal enters an idle state;
a fourth moment, which is a moment when the terminal initiates the CHO for a first time after receiving relevant configuration information of CHO, or a moment when the terminal initiates a random access of the CHO for a first time after receiving the relevant configuration information of CHO;
a time interval from a moment when the relevant configuration information of CHO is received by the terminal to the first moment;
a time interval from a moment when the relevant configuration information of CHO is received by the terminal to the fourth moment a moment when the terminal receives the relevant configuration information of CHO;
a time interval from a moment when the relevant configuration information of CHO is received by the terminal to the second moment;
a moment when the terminal succeeds in or fails in the normal HO or the immediate HO;
a time interval from the first moment to success or failure of a corresponding CHO;
a time interval from the fourth moment to success or failure of a corresponding CHO;
a moment when the CHO is failed or successful;
a time interval from a moment when the relevant configuration information of CHO is received by the terminal to success of the CHO at the terminal;
a time interval from a moment when the relevant configuration information of CHO is received by the terminal to failure of the CHO at the terminal;
a time interval from a moment when the relevant configuration information of CHO is received by the terminal to the third moment;
a time interval from the fourth moment and to success of the CHO at the terminal;
a time interval from the fourth moment to failure of the CHO at the terminal;
a time interval between the fourth moment and the third moment;
a number of times of initiating the CHO;
a number of CHO failures;
position information of the terminal when recording;
configuration of the CHO configured for the terminal, the configuration being at least one of: an HO event or events, a corresponding parameter or parameters, or an identity of a target cell; or
relevant information of a first service performed by the terminal; the first service being a service performed by the terminal when initiating the CHO, or a service performed by the terminal before initiating the HO.

20. The non-transitory storage medium of claim 19, wherein the relevant information of CHO further comprises:
identity information of a second cell; the second cell is a target cell for which the CHO is initiated, or a target cell for which a random access of the CHO is successful or failed.
